(19) United States
(12) Patent Application Publication
(10) Pub. No.: US 2006/0060745 A1
(43) Pub. Date: Mar. 23, 2006

(54) Car crutch

(76) Inventor: Dennis Charlcie Nichols, Basehor, KS (US)

Correspondence Address: Dennis C. Nichols, 2110 N. 147th Street, Basehor, KS, 66007-9623, US

(21) Appl. No.: 11/078,613

(22) Filed: Mar. 11, 2005

Related U.S. Application Data
(60) Provisional application No. 60/610,828, filed on Sep. 20, 2004.

(51) Int. Cl. F16M 11/20

(52) U.S. Cl. 248/352

(57) ABSTRACT

The invention to which this disclosure pertains is a new method to support vehicles in a safer and better manner than methods currently in use today. Currently vehicles being maintained are supported in various methods ranging from blocks of wood or concrete to the common “jack stands”. The “Car Crutch” replaces any previous method of supporting various vehicles in a stronger and more secure manner. An additional benefit is that since the invention is attached to the vehicle hub or axle, it will not be an obstruction to work being performed on the underside of a vehicle such as starter or muffler replacement.

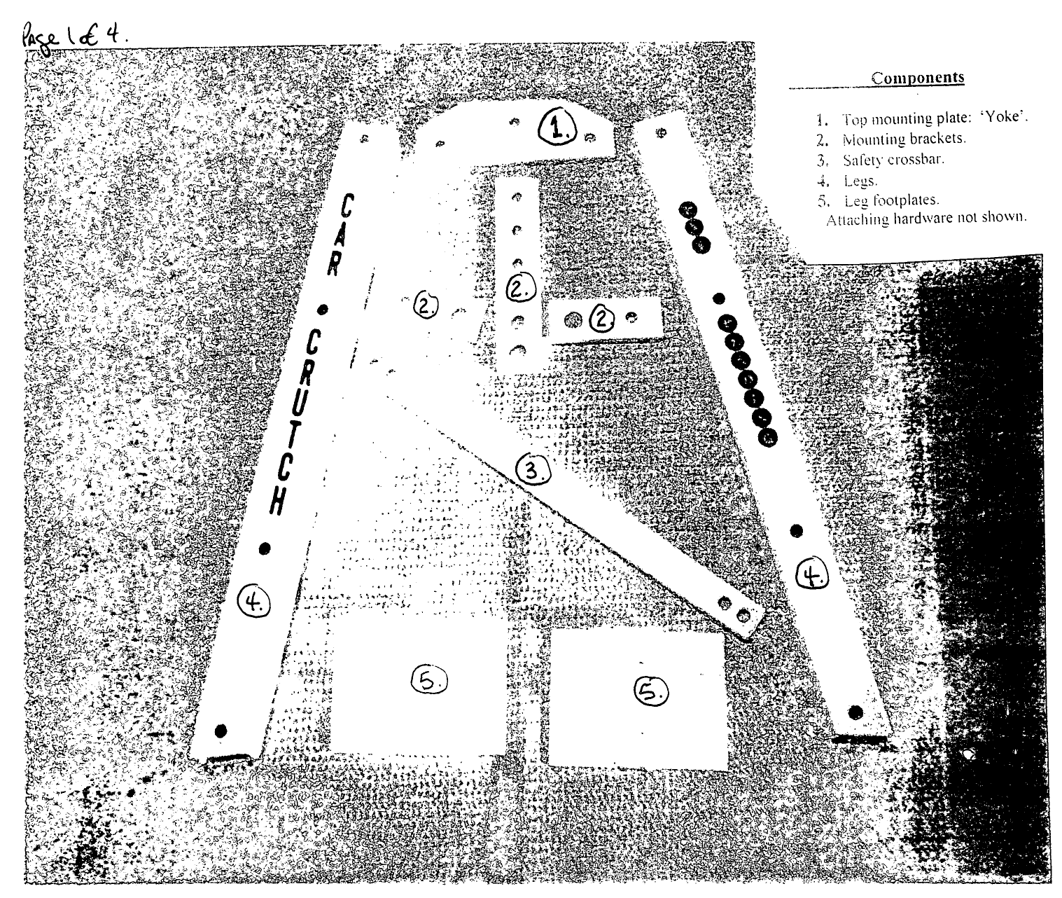

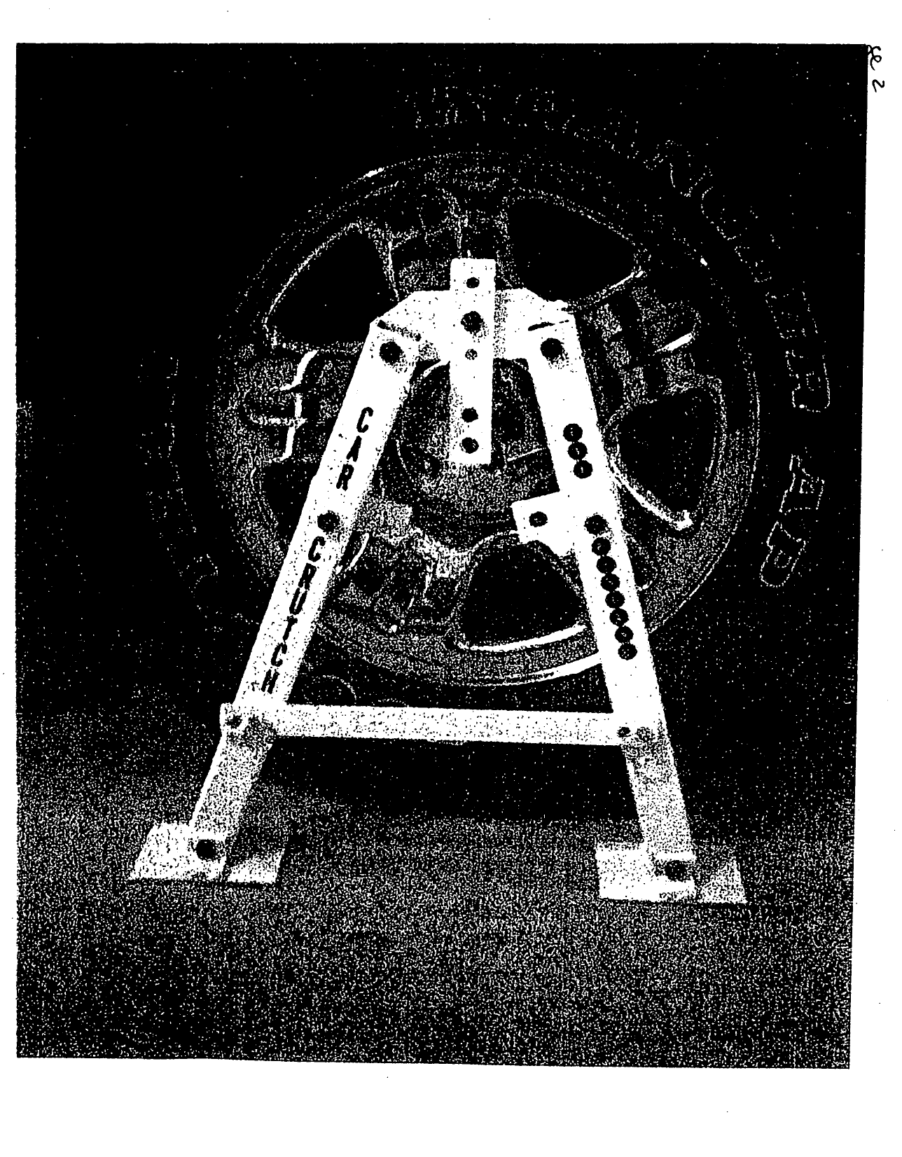

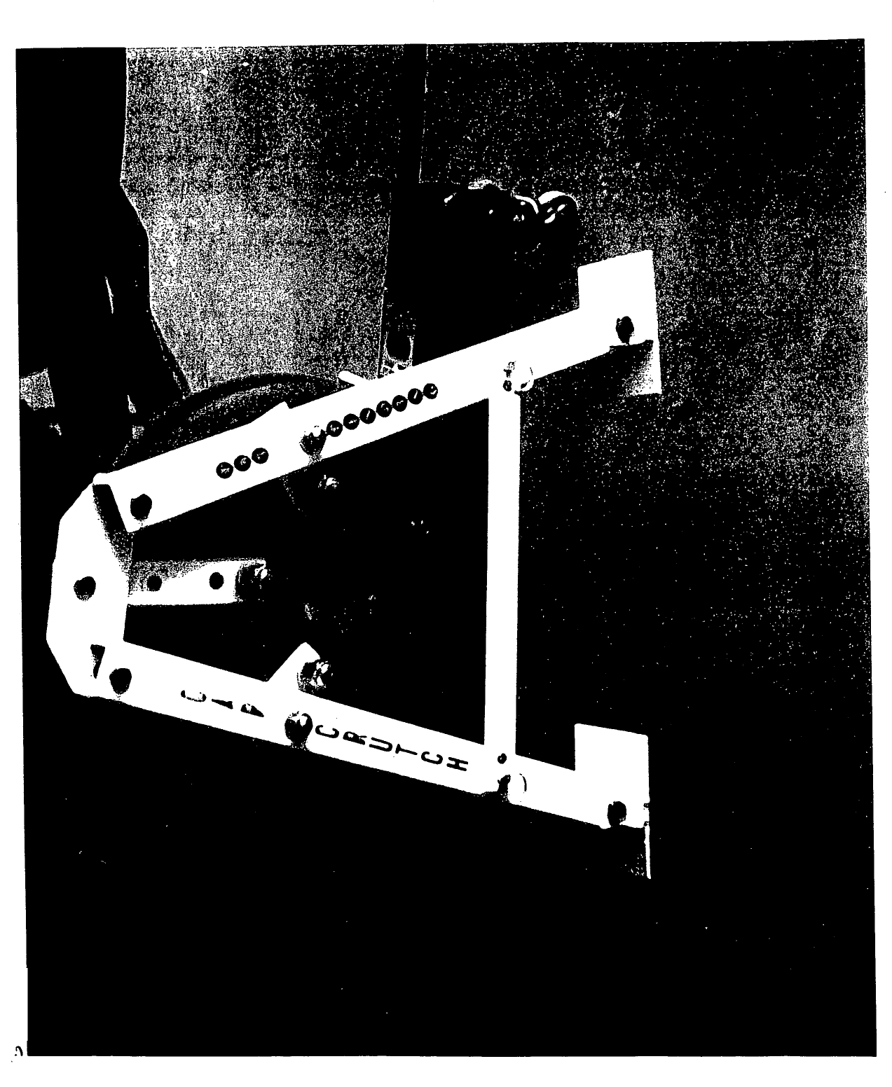

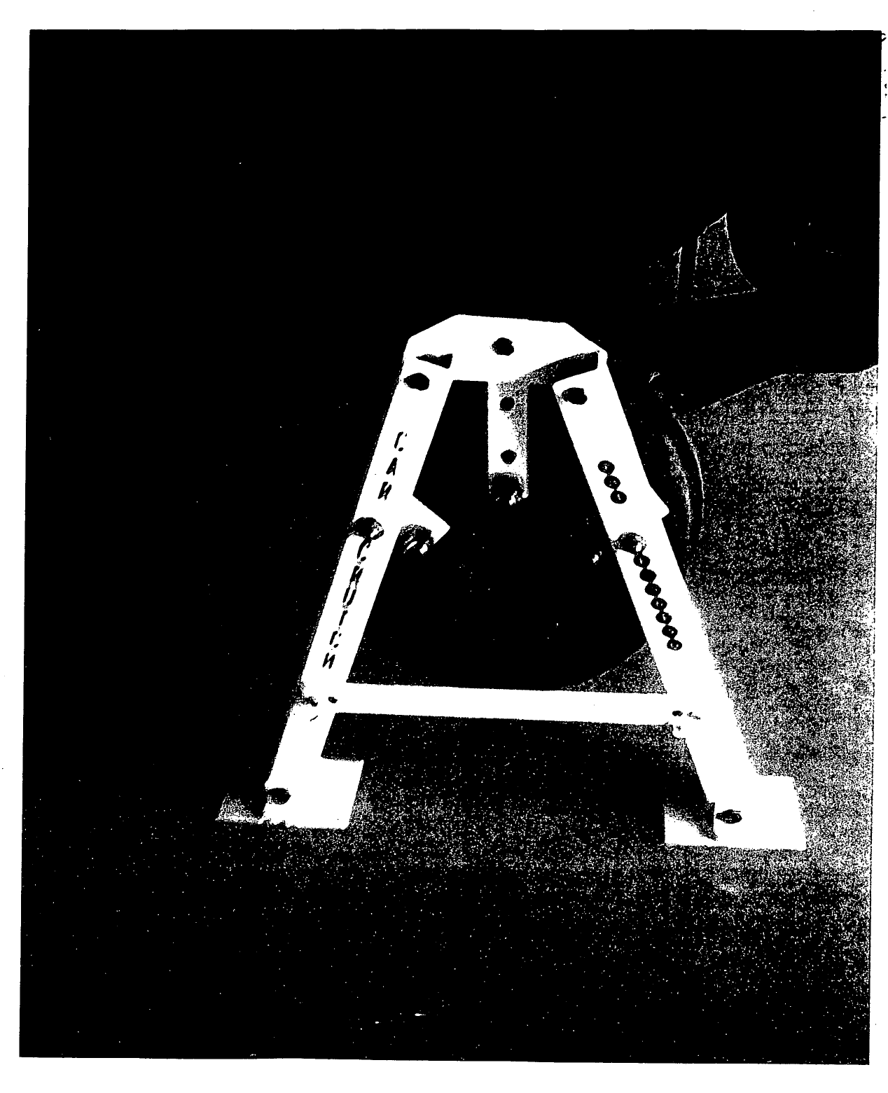

### RELATED APPLICATIONS

Device may also be used to support the hubs and/or axles of other vehicles such as trucks, trailers, farm tractors, airplanes, and generally can be constructed or modified to support almost any type of wheeled vehicle.

### NO FEDERALLY SPONSORED R&D

No sequence listing compact disc included.

### BACKGROUND OF INVENTION

In my experience with performing maintenance on vehicles of different types I discovered a need for a better, more efficient and safer way of supporting the vehicle which would enable removing the jacking device with the vehicle's weight being supported in a strong and positive manner.

### INVENTION SUMMARY

This invention consists of a bipod-type arrangement of attachment plates and square tubing “legs”, with hinged footplates. The attachment plates allow the device to be secured to the vehicle hub and will have the option of a sleeve to allow support of an axle. The legs will have the option of being extendable to provide for adjustable height support of the vehicle.

Four/(4) photocopies are being provided with this RCE.

### DETAILED DESCRIPTION

Device will be portable, compact and with weight commensurate with regard to the type and size of the applicable vehicle. It will consist of a top mounting plate, (yoke), two legs with attachment brackets and hinged footplates and a safety crossbar with adjusting holes that will be attached to the legs by pins.

### Individual Component Description

Top mounting plate: Shall consist of two parts, a flat steel plate with 3 drilled holes, one at each end and one in the center and one piece of flat bar stock with attachment and adjusting holes spaced and drilled. The flat bar stock will be bolted to the mounting plate's center mounting hole, and will be attached to the vehicle hub with a lug bolt protruding through an attachment hole and secured with one of the vehicle's lug nuts or bolts as appropriate. For axle applications, a separate device will be available, consisting of an additional top mounting plate, (yoke) and a sleeve welded to two mounting brackets that will attach to the two yokes. The sleeve will then slide over the vehicle's axle, where it will be secured using the axle washer and nut of the vehicle being supported. The safety cross bar will secure the legs of the Car Crutch for axle applications.

Adjustable legs: Two legs made of square tubing will be bolted to the top mounting plate at each end. Bolted to the legs will be attachment brackets made from flat bar stock with adjustment holes. These attachment brackets will be secured to the vehicle hub with either lug bolts or nuts, creating a solid, non-slipping support structure. Also attached to each leg be a footplate assembly, one bolt will be used to attach the footplates to provide for a limited pivoting action for stability. There will also be an option that can be incorporated with the leg assemblies providing for height adjustment. This will be accomplished by smaller or larger sized square tubing with drilled adjustment holes that will retract or extend into or over the leg assembly and will be secured with ball-release type pins, one for each leg. Height adjustment will provide extra versatility for using this product to support different types of vehicles.

Safety crossbar assembly: Shall consist of one or two pieces of flat bar stock with adjustment holes drilled at each end. The safety crossbar can be either bolted to one leg then secured with a retractable ball type pin on the opposite leg, or can be attached using the pins on both legs. Will provide for adjustment/attachment with spaced adjustment holes at the ends of the bar stock and a corresponding drilled hole in each leg. Note: Although this crossbar assembly may not be required with attachment of the device to a hub, it will be required for utilizing the device to support a vehicle by the axle.

Footplate assembly: Provides for better stability, and distributes weight over a slightly larger area. Constructed by welding L brackets to steel plate with attachment holes drilled and a corresponding attachment/pivot hole drilled through each leg. An additional feature can be incorporated into the footplate assemblies to provide the capability of movement of a hub or axle or movement of the entire vehicle on certain surfaces, with the appropriate number of devices attached. These modified footplate assembly will feature a large recessed ball that would enable moving or positioning the vehicle on flat and hard surfaces.

Claim: This invention is the product of my own individual inspiration and to the best of my memory and knowledge I have never during my lifetime witnessed any similar device in use, nor do I know of any similar device now being used or proposed for use. My idea is proposed to eliminate or lessen the use of jack-stands or other items presently used for vehicle support, it's portability will provide for many applications including increased security for persons stranded without spares due to a flat tire on their vehicle.

I believe myself to be the sole inventor of this product and the concept from which it's design is derived at the time of this submission and that to the best of my knowledge no such product currently exists or is in use.

1. The purpose of this invention is to create a method to support the weight of vehicles in a safer and more secure manner than the various means of support currently being used. This invention can be produced to be very versatile with applications varying according to the size and/or weight of the vehicle being supported, and the invention can also be produced or modified making it adaptable for use with any type of vehicle existing. The intent of this invention is to provide strong, secure and safe support for vehicles during maintenance, repair, or during storage.

2. Although submitted under the title, “Car Crutch”, this invention can be used to support many types of vehicles by hubs or, through use of an adapter by axles as well. It can be produced in a generic manner to adapt to various vehicles or it can be specifically made to apply to a certain vehicle or type of vehicle, and the invention will have weight in proportion to the vehicle application. For lighter weight vehicles such as passenger cars or trailers it is lightweight and portable. The concept for this invention is my sole intellectual property and envisions the idea to create a better, safer and more secure means of support for vehicles when it is necessary to remove the wheels and tires for maintenance, tire repair or rotation or even for storage.
